(19) United States
(12) Patent Application Publication
(10) Pub. No.: US 2008/0187356 A1
(43) Pub. Date: Aug. 7, 2008

(54) Guide Bearing Attachment for a Rotatable Element and a Developer Roller Incorporating Same

(76) Inventors: Samuel Tsui, Hong Kong (CN); Peter Zhang, Shen Zhen City (CN)

Correspondence Address: BERENATO, WHITE & STAVISH, LLC, 6550 ROCK SPRING DRIVE, SUITE 240, BETHESDA, MD, 20817, US

(21) Appl. No.: 11/795,969

(22) PCT Filed: Jan. 25, 2006
(86) PCT No.: PCT/AU06/00082

§ 371 Date: Jul. 25, 2007

(30) Foreign Application Priority Data
Jan. 25, 2005 (AU) 2005900312

(51) Int. Cl. G03G 21/16

(52) U.S. Cl. 399/111; 384/91; 399/279

(57) ABSTRACT

A guide bearing attachment 12 for a rotatable element 10 having at least one end 20, the rotatable element housed within a housing 46 having a substantially circular opening 48 therein, the guide bearing attachment 12 comprising a base portion 22; a projection 32 extending from the base portion 22 at a first side 25; a circular support 30 extending from a side 24 of the base portion 22 opposite the first side 25 and having at least one open end, the open end being of similar shape to, but marginally larger than, the at least one end 20; and fastening means 28, 32. In this configuration, when the rotatable element 10 is accurately positioned at a predetermined location within the housing 46, the at least one end 20 extends into, but not through, the substantially circular opening 48 and is received within the open end of the circular support 30, the circular support 30 maintaining the accurate positioning of the predetermined location by way of a secure connection formed by the fastening means 28, 32 between the base portion 22 and the housing 46.

### FIELD OF THE INVENTION

The invention relates to a guide bearing attachment for a rotatable element and a developer roller incorporating the guide bearing attachment. In particular, the invention relates to a guide bearing attachment that allows the rotatable element to be accurately and securely positioned within a housing at first instance.

### BACKGROUND TO THE INVENTION

The following discussion of the background of the invention is intended to facilitate an understanding of the present invention. However, it should be appreciated that the discussion is not an acknowledgment or admission that any of the material referred to was published, known or part of the common general knowledge in any jurisdiction as at the priority date of the application.

Certain process cartridges are constructed in two parts—the developer housing and the drum housing. The developer housing houses the developer roller. The drum housing houses the photosensitive drum. These housings may form individual cartridges which, when connected, form the process cartridge, or may be components of an integrated process cartridge.

The developer roller plays an important part in the construction of all two-part process cartridges. To elaborate, the developer roller is commonly retained within the developer housing by way of two semi-circular openings. The distance between the two semi-circular openings is slightly greater than the axial length of the operational surface of the developer roller.

At the same time, the developer roller has two long protruding ends that extend from the operational surface. The long protruding ends are co-axial with the axis of rotation of the operational surface. It is the long protruding ends that are received within the semi-circular openings and thereby retain the developer roller in the developer housing.

An additional requirement of the long protruding ends is that they extend past the semi-circular openings to allow for engagement with guiding pathways provided for in the drum housing. In this manner, the long protruding ends of the developer roller facilitate the mating of the developer housing with the drum housing.

The disadvantage of this configuration is that the developer roller is cradled by the semi-circular openings during construction. It is not until the drum housing is mated with the developer housing that the developer roller is fixed in position. The problem this causes is that, while it is possible to accurately position the developer roller at first instance, the intervening steps and time period until the drum housing is mated with the developer housing provides an opportunity for the developer roller to move from this initial position. If this occurs, the developer roller may be fixed into an incorrect position that can cause deterioration in image quality if not corrected.

It is an object of the present invention to provide a support member that overcomes, or at least ameliorates in part, one or more of the above problems.

### SUMMARY OF THE INVENTION

Throughout this document, unless otherwise indicated to the contrary, the terms “comprising”, “consisting of”, and the like, are to be construed as non-exhaustive, or in other words, as meaning “including, but not limited to”.

In accordance with a first aspect of the invention there is a guide bearing attachment for a rotatable element having at least one end, the rotatable element housed within a housing having a substantially circular opening therein, the guide bearing attachment comprising:
a base portion;
a projection extending from the base portion at a first side;
a circular support extending from a side of the base portion opposite the first side and having at least one open end, the open end being of similar shape to, but marginally larger than, the at least one end; and
fastening means,
   where, when the rotatable element is accurately positioned at a predetermined location within the housing, the at least one end extends into, but not through, the substantially circular opening and is received within the open end of the circular support, the circular support maintaining the accurate positioning of the predetermined location by way of a secure connection formed by the fastening means between the base portion and the housing.

The guide bearing attachment may further include a locating projection on the same side as the circular support but spaced therefrom, the locating projection operable to maintain the accurate positioning of a second rotatable element.

The fastening means, in one configuration, may include at least one retaining clip configuration. In the same or an alternative configuration, the fastening means may include at least one lug adapted to be received within an aperture.

Ideally, the projection is a rod and is adapted to be received within a guide roller. The guide roller may be spaced from the base portion by a spring.

In accordance with a second aspect of the invention, there is a developer roller having at least one end, housed within a housing having a substantially circular opening therein, adapted to be received within a guide bearing attachment comprising:
a base portion;
a projection extending from the base portion at a first side;
a circular support extending from a side of the base portion opposite the first side and having at least one open end, the open end being of similar shape to, but marginally larger than, the at least one end; and
fastening means,
   where, when the developer roller is accurately positioned at a predetermined location within the housing, the at least one end extends into, but not through, the substantially circular opening and is received within the open end of the circular support, the circular support maintaining the accurate positioning of the developer roller at the predetermined location by way of a secure connection formed by the fastening means between the base portion and the housing.

In accordance with a third aspect of the invention there is a process cartridge having a developer housing and a drum housing, the developer housing having a substantially circular opening therein and also housing a developer roller having at least one end, the developer roller adapted to be received within a guide bearing attachment comprising:
a base portion;
a projection extending from the base portion at a first side and adapted to be received within a guiding pathway provided for in the drum cartridge;
a circular support extending from a side of the base portion opposite the first side and having at least one open end, the open end being of similar shape to, but marginally larger than, the at least one end; and
fastening means,
   where, when the developer roller is accurately positioned at a predetermined location within the developer housing, the at least one end extends into, but not through, the substantially circular opening and is received within the open end of the circular support, the circular support maintaining the accurate positioning of the developer roller at the predetermined location by way of a secure connection formed by the fastening means between the base portion and the developer housing.

The guide bearing attachment may further include a locating projection on the same side as the circular support but spaced therefrom, the locating projection operable to maintain the accurate positioning of a supply roller.

The fastening means, in one configuration, may include at least one retaining clip configuration. In the same or an alternative configuration, the fastening means may include at least one lug adapted to be received within an aperture.

Ideally, the projection is a rod and is adapted to be received within a guide roller. The guide roller may be spaced from the base portion by a spring. In the preferred embodiment, the guide roller has a frustoconical portion and a hollow cylinder portion equal in size to the smaller end of the frustoconical portion, the hollow cylinder portion adapted to be received within a guiding pathway provided for in the drum cartridge.

### BRIEF DESCRIPTION OF THE DRAWINGS

The invention will now be described, by way of example only, with reference to the accompanying drawings, in which:

FIG. 1 is a cross-sectional view of a rotatable element adapted for use with the present invention.

FIG. 2 is an isometric view of a guide bearing attachment of the present invention.

FIG. 3 is a first side plan view of the guide bearing attachment shown in FIG. 2.

FIG. 4 is a top plan view of the guide bearing attachment shown in FIG. 2.

FIG. 5 is a second side plan view of the guide bearing attachment shown in FIG. 2.

FIG. 6 is an exploded view of the rotatable element shown in FIG. 1 received within a developer housing and secured therein by the guide bearing attachment shown in FIG. 2.

FIG. 7 is an isometric view of a process cartridge showing the mating of the developer housing as shown in FIG. 6 with a drum housing.

### PREFERRED EMBODIMENTS OF THE INVENTION

In accordance with the preferred embodiment of the invention there is a developer roller 10 adapted for use with a guide bearing attachment 12.

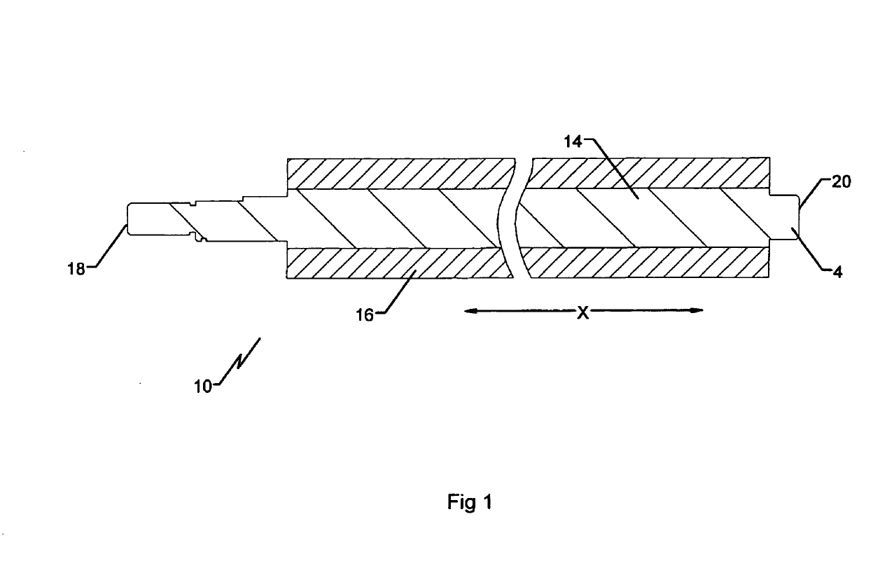

The developer roller 10 is shown in FIG. 1. The developer roller 10 comprises a core shaft 14 encircled along an axial portion thereof by a developing surface 16. This encirclement creates a first end 18 and a second end 20. The first end 18 is substantially longer than the second end 20, when taken in the axial direction X. The relative length of the second end 20 will be discussed in more detail below.

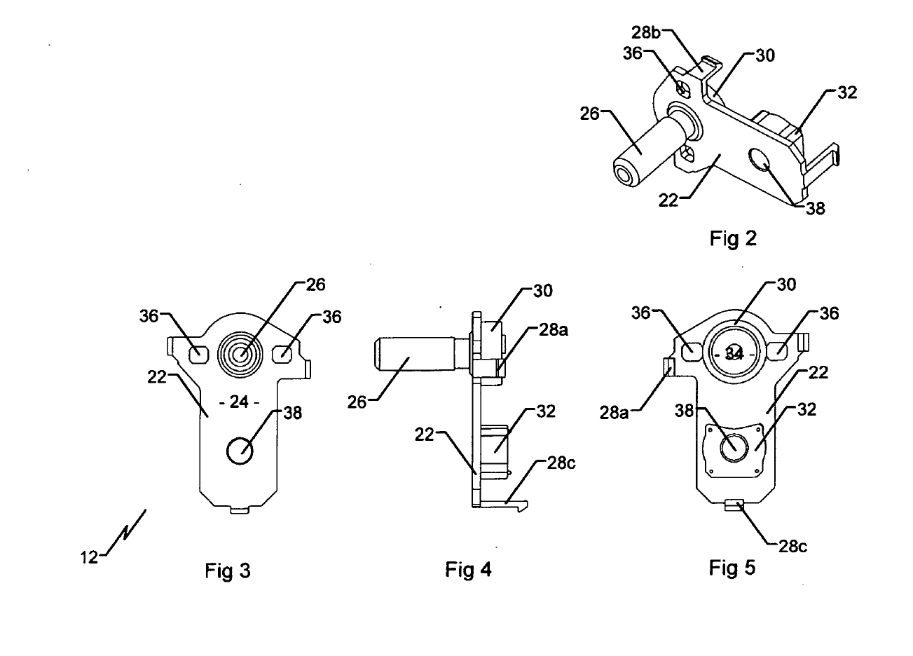

FIGS. 2 through 6 show the guide bearing attachment 12. The guide bearing attachment 12 has a base portion 22. Extending away from the base portion 22 at a first side 24 is a rod 26. Extending away from the base portion 22 at a second side 25, opposite the first side 24, is a plurality of clips 28, a circular support 30 and a locating projection 32.

The circular support 30 and the locating projection 32 are positioned at opposite ends of the guide bearing attachment 12. The circular support 30 is co-axial with the rod 26, creating an extended hollow 34 that spans the interiors of the circular support 30 and the rod 26. The circular support 30 has an interior diameter equal to or marginally greater than the diameter of second end 20. Two apertures 36 are provided at opposite sides of the circular support 30 in a direction transverse to the orientation of the circular support 30 relative to the locating projection 32.

Also spaced from the circular support 30 are two clips 28a, 28b. A third clip 28c is spaced from the locating projection 32. The clips 28 are thus arranged so as to form a substantially “T”-shaped configuration. The intersection of the “T” roughly equates with the centre of the circular support 30.

The locating projection 32 has a circular aperture 38 positioned substantially centrally therein.

A guide roller 39 is adapted to receive the rod 26. The guide roller 39 takes the form of a hollow cylinder portion 40 at one end. The hollow cylinder portion 40 provides a tight fit for the rod 26.

Attached to the hollow cylinder portion 40 is a frustoconical portion 42. The guide roller 38 receives the rod 26 through the frustoconical portion 42 first. When received, the guide roller 38 is spaced from the base portion 22 by the compression of a spring 44.

The invention will now be described in the context of its intended use in the construction of a process cartridge (not shown).

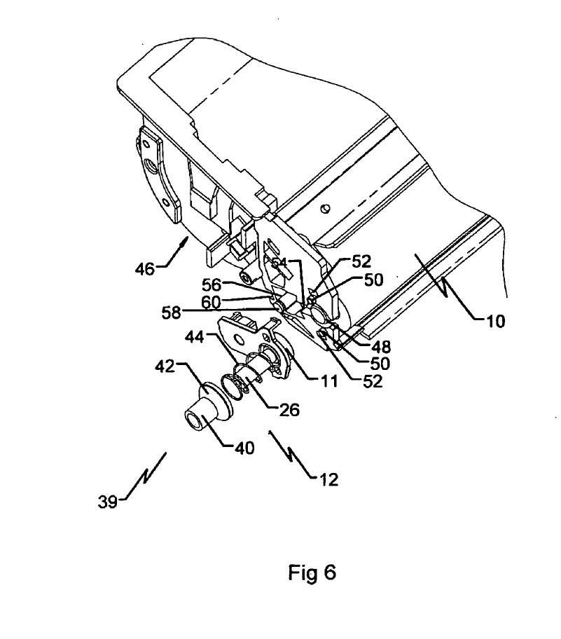

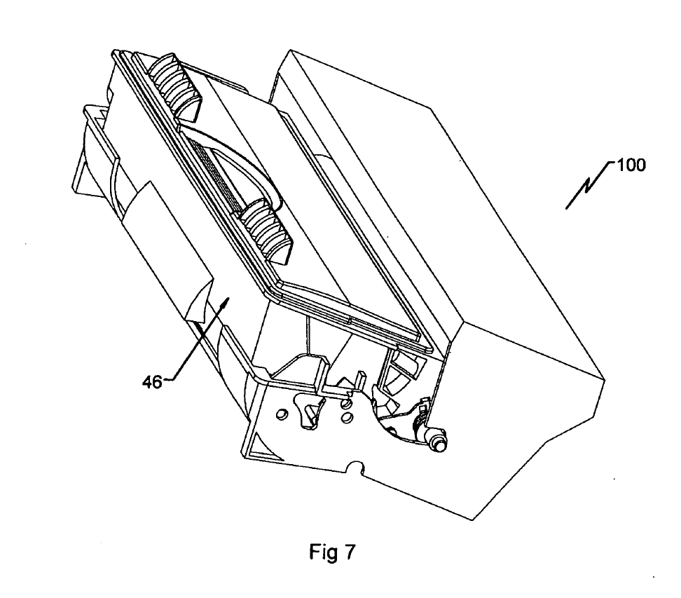

A developer housing 46 is shown in FIG. 6. The developer housing 46 has a substantially circular retaining hole 48 provided therein. Surrounding the retaining hole 48 are two opposing lugs 50. Further spaced from the retaining hole 48 are two recesses 52.

Extending from the substantially circular retaining hole 48 is a first channel 54. The first channel 54 leads to an opening 56. One end of a supply roller 58 is positioned within the opening 56. Adjacent the opening 56 is a second channel 60.

The second end 20 is received within the retaining hole 48. The size of the second end 20 is such, when the developer roller 10 is appropriately positioned, the second end 20 does not protrude through the retaining hole 48. At best, the second end 20 sits flush with the retaining hole 48.

The guide bearing attachment 12 can then be connected to the developer housing 46. This connection is formed by clips 28a, 28b being received within their respective recesses 52. Clip 28c is received within the second channel 60. The mechanics by which the clips 28 are retained with the recesses 52 and second channel 60 are known to the person skilled in the art and need not be described further here. Further ensuring the correct positioning of the guide bearing attachment 12 is the retention of opposing lugs 50 in their respective apertures 36.

When correctly positioned:
the circular support 30 fits securely within retaining hole 48; and
the locating projection 32 fits securely within opening 56.

The secure fitting of the circular support 30 within retaining hole 48 also facilitates the secure retention of the second end 20 within the circular support 30. Similarly, the secure fitting of the locating projection 32 within the opening 56 facilitates the secure retention, and positioning, of the supply roller 58. The exposed end of the supply roller 58 is received within circular aperture 38.

As can be shown by the above example, the inclusion of the guide bearing attachment 12 of the present invention described allows for at least one end of the developer roller 10 being securely retained in an accurate position prior to connection of the drum housing. Furthermore, the guide bearing attachment 12 allows further rotatable elements such as the supply roller 58 to also be accurately located and positioned. All of this is done without interfering with the standard method of connecting two-part process cartridges as is shown by the inclusion of the invention in the process cartridge 100 illustrated in FIG. 7.

It should be appreciated by the person skilled in the art that the above invention is not limited to the embodiment described. In particular, the following modifications and improvements may be made without departing from the scope of the present invention:
The invention is not limited to use with a developer roller. Other rotatable elements, such as the photosensitive drum, agitator and supply roller may be accurately positioned using the guide bearing attachment described.
The invention can be modified such that the developer roller 10 effectively has ends of equivalent size and shape to second end 20. Guide bearing attachments 12 can then be fitted to either side of the developer housing to ensure secure retention and accurate positioning of the developer roller 10.
Fasteners other than clips can be used to accurately connect the guide bearing attachment to the developer housing. For instance, oversize deformable plugs can be squeezed through apertures to form a secure connection. Still further, a simple screw configuration can be used to produce the required secure connection. Still other configurations would be known to the person skilled in the art and are not to be considered beyond the scope of the present invention.
Similarly, the retention of opposing lugs 50 within apertures 36 may also be omitted, or replaced with an alternative fastening configuration as described in the previous paragraph.
The shape of the rod 26 and/or guide roller 39 may also differ from that described. However, the shape of the rod 26 and guide roller 39 are dictated by two considerations: a) the internal configuration of the rod 26 or guide roller 39 must be such as not to restrict the rotation of the rotatable element; and b) the external configuration of the rod 26 or guide roller 39 must be such as to facilitate engagement of the guide roller 59 with the guiding pathways provided for in the drum housing.
While the invention has been described in the context of a process cartridge, the invention may be applied to other cartridge types.

It should be further appreciated by the person skilled in the art that the features described in one embodiment, where not mutually exclusive or alternatives, may be combined with features described in other embodiments to create yet further embodiments that fall within the scope of the present invention.

1. A guide bearing attachment for a rotatable element having at least one end, the rotatable element housed within a housing having a substantially circular opening therein, the guide bearing attachment comprising:
a base portion;
a projection extending from the base portion at a first side;
a circular support extending from a side of the base portion opposite the first side and having at least one open end, the open end being of similar shape to, but marginally larger than, the at least one end; and
fastening means, where, when the rotatable element is accurately positioned at a predetermined location within the housing, the at least one end extends into, but not through, the substantially circular opening and is received within the open end of the circular support, the circular support maintaining the accurate positioning of the predetermined location by way of a secure connection formed by the fastening means between the base portion and the housing.

2. A guide bearing attachment according to claim 1, where the base portion further includes a locating projection on the same side as the circular support but spaced therefrom, the locating projection operable to maintain the accurate positioning of a second rotatable element.

3. A guide bearing attachment according to claim 1, where the fastening means includes at least one retaining clip.

4. A guide bearing attachment according to claim 1, where the fastening means includes at least one lug adapted to be received within an aperture.

5. A guide bearing attachment according to claim 1, where the projection is a rod.

6. A guide bearing attachment according to claim 1, where the projection is adapted to be received within a guide roller.

7. A guide bearing attachment according to claim 6, where the guide roller is spaced from the base portion by a spring.

8. A developer roller having at least one end, housed within a housing having a substantially circular opening therein, adapted to be received within a guide bearing attachment comprising:
a base portion;
a projection extending from the base portion at a first side;
a circular support extending from a side of the base portion opposite the first side and having at least one open end, the open end being of similar shape to, but marginally larger than, the at least one end; and
fastening means, where, when the developer roller is accurately positioned at a predetermined location within the housing, the at least one end extends into, but not through, the substantially circular opening and is received within the open end of the circular support, the circular support maintaining the accurate positioning of the developer roller at the predetermined location by way of a secure connection formed by the fastening means between the base portion and the housing.

9. A cartridge having a developer housing and a drum housing, the developer housing having a substantially circular opening therein and also housing a developer roller having at least one end, the developer roller adapted to be received within a guide bearing attachment comprising:
a base portion;
a projection extending from the base portion at a first side and adapted to be received within a guiding pathway provided for in the drum housing;
a circular support extending from a side of the base portion opposite the first side and having at least one open end, the open end being of similar shape to; but marginally larger than, the at least one end; and
fastening means, where, when the developer roller is accurately positioned at a predetermined location within the developer housing, the at least one end extends into, but not through, the substantially circular opening and is received within the open end of the circular support, the circular support maintaining the accurate positioning of the developer roller at the predetermined location by way of a secure connection formed by the fastening means between the base portion and the developer housing.

10. A cartridge according to claim 9, where the base portion further includes a locating projection on the same side as the circular support but spaced therefrom, the locating projection operable to maintain the accurate positioning of a supply roller.

11. A cartridge according to claim 9, where the fastening means includes at least one retaining clip configuration.

12. A cartridge according to claim 9, where the fastening means includes at least one lug adapted to be received within an aperture.

13. A cartridge according to claim 9, where the projection is a rod.

14. A cartridge according to claim 9, where the projection is adapted to be received within a guide roller.

15. A cartridge according to claim 14, where the guide roller has a frustoconical portion and a hollow cylinder portion equal in size to the smaller end of the frustoconical portion, the hollow cylinder portion adapted to be received within a guiding pathway provided for in the drum housing.

16. A cartridge according to claim 14, where the guide roller is spaced from the base portion by a spring.

17-19. (canceled)
